(19) United States
(12) Patent Application Publication
(10) Pub. No.: US 2006/0218387 A1
(43) Pub. Date: Sep. 28, 2006

(54) SYSTEM AND METHOD FOR BACKUP AND RECOVERY OF DATA STORED IN A HARD DISK OF A COMPUTER

(76) Inventors: Xing-Xing Fu, Shenzhen (CN); Ri-Sheng Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,214

(22) Filed: Jan. 26, 2006

(30) Foreign Application Priority Data
Mar. 25, 2005 (CN) 200510033858.9

(51) Int. Cl. G06F 9/00

(52) U.S. Cl. 713/2

(57) ABSTRACT

The present invention provides a computer system (10) including a CPU (central process unit) (101), a memory (102), a hard disk (103) storing data to be backupped, and a BIOS ROM (basic input/output system read only memory) (104). The BIOS ROM stores codes of BIOS (1041) of the computer system and codes of a backup and recovery program (1042). The backup and recovery program includes codes for dividing a portion of free storing space of the hard disk as a backup partition for backup of the data stored in the hard disk, codes for copying the data stored in the hard disk to be backupped into the backup partition as a backup, and codes for releasing the storing space of the backup partition. The CPU reads the codes from the BIOS ROM and executes the codes in a particular segment of the memory. A related computer based method is also provided.

### FIELD OF THE INVENTION

The present invention is generally related to systems and methods for securing a computer, and, more particularly to a system and method for securing data stored in a hard disk of a computer.

### DESCRIPTION OF RELATED ART

A hard disk is a static medium for storing data, and is a main component of a personal computer. A hard disk may provide a huge volume of storing space for a user storing a large amount of data. A home user may use a hard disk for storing multimedia files for entertainment, such as movies and music songs. A company user may use the hard disk for storing data concerning operation of the company, most of which are trade secrets and are not backupped in another medium, such as traditional paper files. Both home users and company users more and more depend on hard disks for holding data and information. However, a computer may break down due to various causes, such as an incorrect deletion on the hard disk, or a virus application attacking the computer under the OS (operation system). Once such event happens, the data stored in the hard disk may be destroyed, and can not be recovered if no copy is made previously.

There are some solutions to remedy, such as a hard disk protect card and a backup and recovery program for a hard disk. The hard disk protect card strictly controls the OS or other applications to access the hard disk, especially to write data into the hard disk and to delete data from the hard disk. The backup and recovery program is typically an application installed under the OS for controlling the OS or other applications to access the hard disk similarly to the hard disk protect card. However, the hard disk protect card is an extra expense for a computer user and is somewhat inconvenient for a new user to use. The backup and recovery program is always resident in the memory of the computer under the OS so as to keep watching and controlling access of the hard disk. As the memory is a scarce resource, the backup and recovery program wastes the memory so that the performance of the whole computer system lowers down.

Accordingly, what is needed is a solution utilizing a backup and recovery program to protect the hard disk without always residence in the memory of the computer system.

### SUMMARY OF INVENTION

One embodiment of a computer system can be implemented as described herein. The computer system includes a CPU (central process unit), a memory, a hard disk storing data to be backupped, and a BIOS ROM (basic input/output system read only memory). The BIOS ROM stores codes of BIOS of the computer system and codes of a backup and recovery program. The backup and recovery program includes codes for dividing a portion of free storing space of the hard disk as a backup partition for backup of the data stored in the hard disk, codes for copying the data stored in the hard disk to be backupped into the backup partition as a backup, and codes for releasing the storing space of the backup partition. The CPU reads codes from the BIOS ROM and executes the codes in a particular segment of the memory.

One embodiment of a computer-based method for backup and recovery of data stored in a hard disk of a computer having a memory can be implemented as described herein. The method includes the steps of: providing a BIOS ROM (basic input/output system read only memory) storing codes of BIOS of the computer system and codes of a backup and recovery program, the backup and recovery program providing functions of backup and recovery of the data stored in the hard disk; executing the POST (power on self testing) program in the computer; reading the codes of the backup and recovery program; executing the backup and recovery program in a particular segment of the memory of the computer; and removing the codes of the backup and recovery program from the particular segment of the memory of the computer.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram illustrating configuration of a computer system in accordance with one embodiment;

FIG. 2 is a flow chart illustrating a method for backup and recovery of data stored in a hard disk of the computer system in FIG. 1;

FIG. 3 is a schematic diagram illustrating function menus of a backup and recovery program in FIG. 1;

FIG. 4 is a flow chart illustrating a process of dividing a backup partition by selecting one option of the function menus in FIG. 3; and

FIG. 5 is a flow chart illustrating a process of releasing a backup partition by selecting another option of the function menus in FIG. 3.

### DETAILED DESCRIPTION

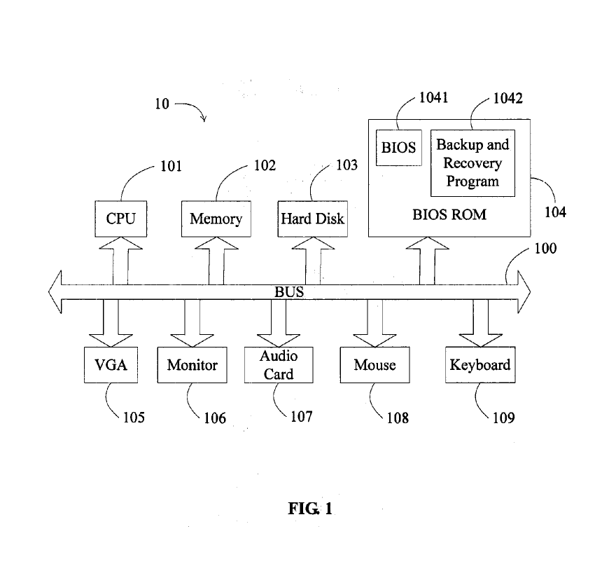

FIG. 1 is a schematic diagram illustrating configuration of a computer system in accordance with one embodiment. The computer system 10 may be an IBM architecture PC (personal computer). Typically, the computer system 10 includes a bus 100 and various devices coupled thereto, such as a CPU (central process unit) 101, a memory 102, a hard disk 103, a BIOS ROM (basic input/output system read only memory) 104, a VGA (video graphic adapter) 105, a monitor 106, an audio card 107, a mouse 108, and a keyboard 109. The computer system 10 may further include other devices, such as a motherboard and a network adapter.

The bus 100 is used for data exchange between the above mentioned devices. The CPU 101 is used for processing codes or instructions in the memory 102. The memory 102 is used for temporarily storing codes or instructions to be processed by the CPU 101. The hard disk 103 is used for storing data. Such data may be personal data such as movie files or song files, or data concerning operation of a company. The monitor 106 is used for displaying data or GUI (graphic user interface) to users. The VGA 105 and audio card 107 are respectively used for optimizing data displaying and audio outputting. The mouse 108 and keyboard 109 are collectively used for a user operating the computer system 10.

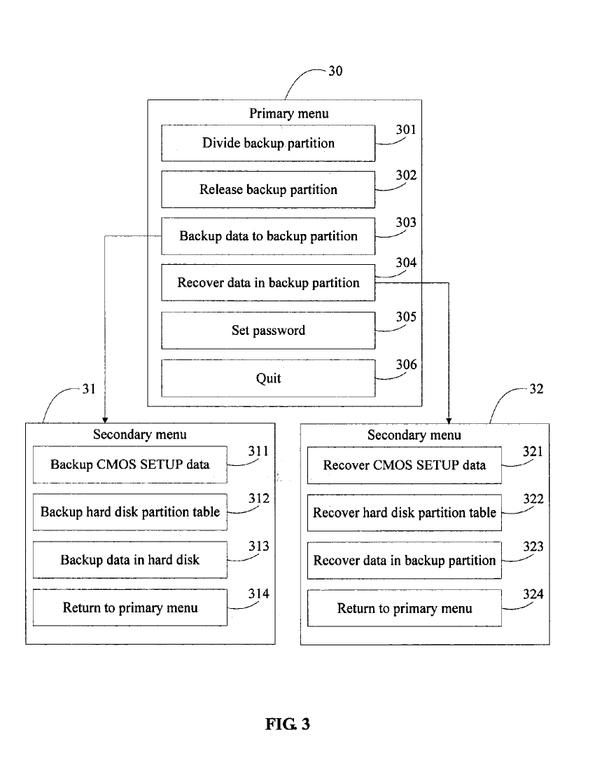

In the preferred embodiment, the BIOS ROM 104 stores codes of BIOS 1041 of the computer system 10 as a typical PC, and in addition, stores codes of a backup and recovery program 1042 (hereinafter “the program 1042”). The program 1042 includes a first module for dividing a portion of free storing space of the hard disk 103 as a backup partition for backup of data stored in the hard disk 103, a second module for copying the data stored in the hard disk 103 to be backupped into the backup partition as a backup, and a third module for releasing the storing space of the backup partition. The program 1042 may further include a fourth module for compressing the data to be backupped before copying the data into the backup partition as a backup in order that the data take up less storing space than its actual size in the backup partition. The program 1042 may further include other modules, such as a module for setting a password for accessibility to the program 1042. Further illustration of the program 1042 is provided below in relation to FIG. 3.

Further, the first module of the program 1042 may include codes for setting a volume of the backup partition, which is less than the total volume of the hard disk, codes for allocating the portion of free storing space for the backup partition according to the volume of the backup partition, and codes for setting the backup partition as a hidden and inaccessible partition to the OS (operating system) installed in the computer system 10.

Moreover, the third module of the program 1042 may include codes for recovering the backup partition to a visible and accessible partition to the OS installed in the computer system 10, and codes for taking back the storing space of the backup partition.

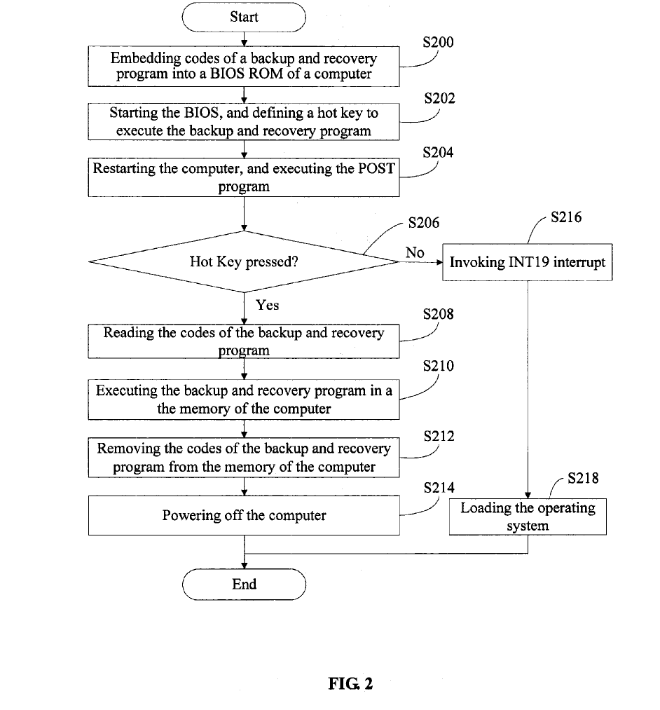

With the program 1042, the computer system 10 can be used for backup and recovery of the data stored in the hard disk 103. Specifically, a user inputs commands through the mouse 108 and/or the keyboard 109 after powering on the computer system 10, and the CPU 101 reads codes of the program 1042 from the BIOS ROM 104 and executes the codes in a particular segment of the memory 102, such as the segment addressing from 90000H to A0000H of the memory 102. Detailed illustration of the process is provided below in relation to FIGS. 2-5.

FIG. 2 is a flow chart illustrating a method for backup and recovery of the data stored in the hard disk 103. In step S200, a programmer embeds the codes of the program 1042 into the BIOS ROM 104. That is, both the codes of the program 1042 and codes of the BIOS 1041 of the computer system 10 are stored in the BIOS ROM 104. In step S202, a user powers on the computer system 10 to load the BIOS 1041 in order to execute the POST (power on self testing) program, defines a hot key to trigger the execution of the program 1042 during the execution of the POST program, and powers off the computer system 10 after saving the hot key in the BIOS 1041. The hot key can be any one or a combination of keys on the keyboard 109, whatever the user prefers.

In step S204, the user restarts the computer system 10, and the computer system 10 executes the POST program again. The POST program tests all devices configured in the computer system 10, and initiates the devices, such as the VGA 105, chipsets on the motherboard of the computer system 10, USB (universal serial bus) ports, and IDE (integrated drive electronics) devices. The hard disk 103 is an IDE device which has an IDE port. During the process of POST, the user may press the hot key as predefined in step S202 through the keyboard 109.

In step S206, the BIOS 1041 keeps watching the input of the keyboard 109 after initiating the IDE devices, and determines if the hot key is pressed by the user. If the hot key is pressed by the user, in step S208, the CPU 101 reads the codes of the program 1042 from the BIOS ROM 104 into the memory 102. The codes of the program 1042 are temporarily stored in a particular segment of the memory 102 until the CPU 101 finishes executing the program 1042. The particular segment of the memory 102 may address from 90000H to A0000H. In step S210, the CPU 101 executes the program 1042 in the particular segment of the memory 102. The user may choose functions of the program 1042 to backup or recover the data stored in the hard disk 103 by selecting options of function menus provided by the program 1042 as described in relation to FIG. 3. The user may select “quit” to finish the program 1042. In step S212, the CPU 101 removes the codes of the program 1042 from the memory 102 after the CPU 101 finished the execution of the program 1042. In step S214, the user conducts other operations on the computer system 10 or powers off the computer system 10.

On the other hand, if the hot key is not pressed by the user, in step S216, the CPU 101 invokes the INT 19 interrupt to normally continue booting of the computer system 10, and in step S218, the CPU 101 loads the OS (operating system) of the computer system 10.

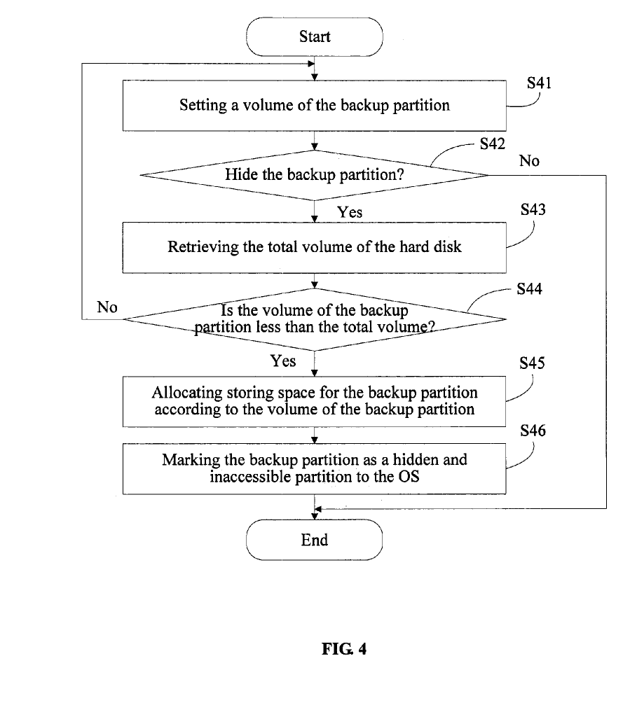

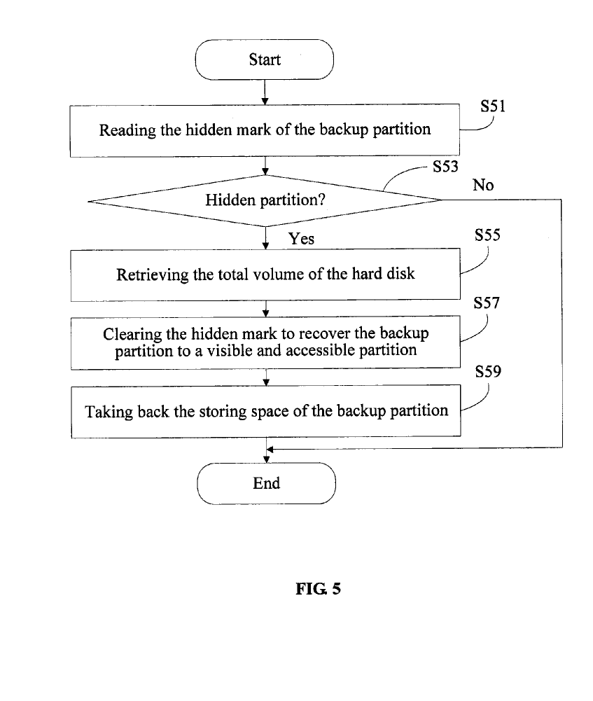

FIG. 3 is a schematic diagram illustrating the function menus of the program 1042. The program 1042 provides a primary menu 30 to the user through a GUI (graphic user interface) on the monitor 106. The primary menu 30 includes a plurality of options, each of which corresponds to a function for the user to select for execution. The plurality of options mainly include an option 301 for dividing a backup partition, an option 302 for releasing the backup partition, an option 303 for backupping data to the backup partition, an option 304 for recovering data in the backup partition, an option 305 for setting a password for accessibility to the program 1042, and an option 306 for quitting the program 1042. In an alternative embodiment, the primary menu 30 may include other options corresponding to functions according to special requirements. If the user selects the option 301, the program 1042 divides a portion of free storing space of the hard disk 103 as a backup partition for backup of the data stored in the hard disk 103. The process of dividing a backup partition is described below in relation to FIG. 4. If the user selects the option 302, the program 1042 releases the storing space of the backup partition. The process of releasing the backup partition is described below in relation to FIG. 5. If the user selects the option 303, the program 1042 provides a secondary menu 31 including a plurality of options for further selecting. If the user selects the option 304, the program 1042 provides a secondary menu 32 including a plurality of options for further selecting.

The secondary menu 31 includes an option 311 for selecting backup of CMOS (complementary metal oxide semiconductor) SETUP data, an option 312 for selecting backup of hard disk partition table of the hard disk 103, an option 313 for selecting backup of the data in the hard disk 103 that need to be backupped, an option 314 for selecting to return to the primary menu 30. If the user selects the option 313, the program 1042 copies the data stored in the hard disk 103 to be backupped into the backup partition as a backup. In an alternative embodiment, the secondary menu 31 may further include an option for selecting to compress the data to be backupped before copying the data into the backup partition as a backup (not shown), in order that the data take up less storing space than its actual size in the backup partition.

The secondary menu 32 includes an option 321 for selecting to recover CMOS SETUP data, an option 322 for selecting to recover the hard disk partition table of the hard disk 103, an option 323 for selecting to recover the data in the backup partition, and an option 324 for selecting to return to the primary menu 30.

FIG. 4 is a flow chart illustrating the process of dividing a backup partition. If the user selects the option 301 of FIG. 3, in step S41, the program 1042 provides a GUI for the user setting a volume to be allocated for the backup partition. The volume should be less than the total volume of the hard disk 103. In step S42, the program 1042 provides a GUI for the user to select whether the backup partition needs to be hidden or not. If the user selects not to hide the backup partition, the procedure ends. Otherwise, if the user selects to hide the backup partition, in step S43, the program 1042 retrieves the total volume of the hard disk 103. In step S44, the program 1042 determines if the volume of the backup partition is less than the total volume of the hard disk 103. If the volume of the backup partition is less than the total volume of the hard disk 103, in step S45, the program 1042 allocates a portion of free storing space for the backup partition according to the volume of the backup partition. In step S46, the program 1042 sets and marks the backup partition as a hidden and inaccessible partition to the OS (operating system) installed in the computer system 10. If according to step S44 the volume of the backup partition is less than the total volume of the hard disk 103, the procedure returns to step S41 for the user to set a proper volume for the backup partition.

FIG. 5 is a flow chart illustrating the process of releasing the backup partition. If the user selects the option 302 of FIG. 3, in step S51, the program 1042 reads the hidden mark of the backup partition. In step S53, the program 1042 determines if the backup partition is a hidden partition according to its hidden mark. If the backup partition is not a hidden partition, the procedure ends. Otherwise, if the backup partition is a hidden partition, in step S55, the program 1042 retrieves the total volume of the hard disk 103. In step S57, the program 1042 clears the hidden mark to recover the backup partition to a visible and accessible partition to the OS installed in the computer system 10. In step S59, the program 1042 takes back the storing space of the backup partition. In an alternative embodiment, the program 1042 makes sure that there is no data stored in the backup partition before taking back the storing space.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A computer system comprising:
a memory;
a hard disk storing data to be backupped; and
a BIOS ROM (basic input/output system read only memory) storing codes of BIOS of the computer system and codes of a backup and recovery program, the backup and recovery program comprising:
codes for dividing a portion of free storing space of the hard disk as a backup partition for backup of the data stored in the hard disk;
codes for copying the data stored in the hard disk to be backupped into the backup partition as a backup; and
codes for releasing the storing space of the backup partition; and
a CPU (central process unit) for reading the codes from the BIOS ROM and executing the codes in a particular segment of the memory.

2. The computer system according to claim 1, wherein the codes for dividing a portion of free storing space of the hard disk as a backup partition comprise:
codes for setting a volume of the backup partition, the volume being less than the total volume of the hard disk;
codes for allocating the portion of free storing space for the backup partition according to the volume of the backup partition; and
codes for setting the backup partition as a hidden and inaccessible partition to the OS (operating system) installed in the computer system.

3. The computer system according to claim 1, wherein the backup and recovery program further comprises codes for compressing the data to be backupped.

4. The computer system according to claim 1, wherein the codes for releasing the storing space of the backup partition comprise:
codes for recovering the backup partition to a visible and accessible partition to the OS installed in the computer system; and
codes for taking back the storing space of the backup partition.

5. The computer system according to claim 1, wherein the particular segment of the memory addresses from 90000H to A0000H of the memory.

6. A computer-based method for backup and recovery of data stored in a hard disk of a computer system having a memory, the method comprising the steps of:
providing a BIOS ROM (basic input/output system read only memory) storing codes of BIOS of the computer system and codes of a backup and recovery program, the backup and recovery program providing functions of backup and recovery of the data stored in the hard disk;
executing the POST (power on self testing) program in the computer system;
reading the codes of the backup and recovery program;
executing the backup and recovery program in a particular segment of the memory of the computer system; and
removing the codes of the backup and recovery program from the particular segment of the memory.

7. The method according to claim 6, further comprising the step of: defining a hot key to trigger the execution of the backup and recovery program during the execution of the POST program.

8. The method according to claim 7, further comprising the step of: pressing the hot key to trigger the execution of the backup and recovery program.

9. The method according to claim 6, wherein the step of executing the backup and recovery program comprises the step of: dividing a portion of free storing space of the hard disk as a backup partition for backup of the data stored in the hard disk.

10. The method according to claim 9, wherein the step of dividing a portion of free storing space of the hard disk as a backup partition comprises the steps of:
setting a volume of the backup partition, the volume being less than the total volume of the hard disk;
allocating the portion of free storing space for the backup partition according to the volume of the backup partition; and
setting the backup partition as a hidden and inaccessible partition to the OS (operating system) installed in the computer system.

11. The method according to claim 9, wherein the step of executing the backup and recovery program further comprises the step of: releasing the storing space of the backup partition.

12. The method according to claim 11, wherein the step of releasing the storing space of the backup partition comprises the step of:
recovering the backup partition to a visible and accessible partition to the OS installed in the computer system; and
taking back the storing space of the backup partition.

13. The method according to claim 9, wherein the step of executing the backup and recovery program further comprises the step of: copying the data stored in the hard disk to be backupped into the backup partition as a backup.

14. The method according to claim 13, wherein the step of executing the backup and recovery program further comprises the step of: compressing the data to be backupped before the copying step.

15. The method according to claim 13, wherein the step of executing the backup and recovery program further comprises the step of: recovering the data in the backup partition.

16. The method according to claim 6, wherein the particular segment of the memory of the computer system addresses from 90000H to A0000H of the memory.
